(19) United States
(12) Patent Application Publication
(10) Pub. No.: US 2009/0048816 A1
(43) Pub. Date: Feb. 19, 2009

(54) Method for on-line prediction of future performance of a fermentation unit

(75) Inventors: Babji Buddhi Srinivasa, Bangalore (IN); Jayant Modak Moreshwar, Bangalore (IN)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 12/219,778

(22) Filed: Jul. 28, 2008

Related U.S. Application Data
(63) Continuation of application No. PCT/IB2006/000155, filed on Jan. 28, 2006.

(51) Int. Cl. G06G 7/50

(52) U.S. Cl. 703/11

(57) ABSTRACT

A method is disclosed for on-line prediction of performance of a fermentation unit, such as prediction of performance parameters like concentration of product, biomass, or sugar in the broth of a batch/fed-batch fermentation unit containing bacteria and nutrients. A computer model predicts a future product concentration based on current plant data. While a batch is in progress, model parameters are adjusted on-line based on plant data to reduce a mismatch between the plant data and model data. A method/fermenter model can be implemented as a software program in a PC that can be interfaced to a plant control system for on-line deployment in an actual plant environment. An on-line performance monitoring system can be used by plant operating personnel, to know the performance of the batch in advance for implementing corrective measures in advance to improve/maintain performance at desired level.

### RELATED APPLICATION

This application claims priority as a continuation application under 35 U.S.C. §120 to PCT/IB2006/000155 filed as an International Application on 28 Jan. 2006 designating the U.S., the entire content of which is hereby incorporated by reference in its entirety.

### TECHNICAL FIELD

The present disclosure deals with prediction of future performance of a fermentation unit provided with computer based data acquisition and control system, including parameters such as concentration of biomass, sugar and product of a batch/fed batch fermentation unit.

### BACKGROUND INFORMATION

Fermentation processes involve a growth of microorganisms, utilizing the substrates and/or nutrients supplied and the formation of desired products. These processes are carried out in a stirred tank or other type of bioreactors with precise control of process conditions such as temperature, pH and dissolved oxygen. Due to complex metabolic networks and their regulation operating in the cell, the control of substrates and/or nutrients at appropriate levels is desired for the formation of the products. Quite often, fermentation processes are carried out in batch/fed-batch mode with the main concern being a reduction in variations in performance and yield from batch to batch.

In a batch fermentation unit, broth samples are analyzed every few hours in the laboratory for the concentrations of biomass, product and substrate to arrive at the performance of the unit. This approach is slow and a model based on systemic on-line monitoring will help in the timely detection of faults and in the implementation of suitable corrective actions to maintain desired performance. Process variables like sugar feed rate are adjusted to maintain the performance of the batch at desired levels. Factors like changes in characteristics of initial charge media, quality of the raw materials used and variations in process conditions influence the performance of the fermentation unit, resulting in considerable variations in the batch yields. Thus, a model for predicting the future performance of the fermentation batch based on real operating data will be a very useful tool in operation of the industrial fermenters.

Different approaches have been adopted to model batch/fed-batch fermentation units.

### Data Driven Models:

Fermenter models based on multivariate statistical algorithms (principal component analysis—PCA and Partial least squares-PLS) and Artificial Neural Networks (ANN) have been reported [Ignova M et al (1997), Lennox et al (2000), Karim M N et al (2003) Lopes et al (2002), Lennox et al (2002)] [Refs. 1 to 5] for monitoring and predicting the performance of the batch/fed-batch fermentation unit.

Multivariate statistics techniques like PCA and PLS and ANN based methods can be limited in their effectiveness when applied to batch processes due to the following reasons:
Batch processes are highly non-linear and operate around pre-specified trajectories, rather than fixed levels.
Batch data sets have been stored in 3-dimensional arrays and can involve considerable effort and approximation in order to transform the three dimensional batch data to two-dimensional arrays, suitable for model development.
Run length and corresponding size of the data set will be different for each batch.
On-line monitoring using data driven models can require that values of all future process measurements (from current time to the end of the batch) are available for calculations.

ANN based models use a large volume of data for model tuning and validation and cannot be easily extrapolated to different operating conditions. Thus, data driven modeling techniques are not suitable for developing models for on-line performance monitoring of batch fermentation units.

### Phenomenological Models:

Fermenter models based on first principles, considering both kinetics and transport phenomena occurring in the fermentation process have also been reported in the literature.

Dhir et. al. [“Dynamic Optimization of Hybridoma growth in a fed batch Bioreactor”, Biotechnology and Bioengineering, 67(2), 197-205, 2000] [Ref. 6] have used a phenomenological model to represent the behavior of the fermenter, using an approach based on fuzzy logic to update the model parameters to match the model predictions with plant data. Fuzzy logic based approaches use trial and error processes that involve adjusting many parameters. Iyer M S et. al. [“Dynamic Reoptimization of a Fed-Batch Fermentor”, Biotechnology and Bioengineering, 63(1), 10-21, 1999.] [Ref. 7] use a non-iterative single step Newton method to update the model parameters of a phenomenological model. This method helps in reducing the model mismatch but does not minimize it. Both these methods were tested on simulated models and laboratory fermenters and are not based on real industrial scale fermenters.

### Present Work:

Fermenter models based on phenomenological approaches as described above do not aim at estimating the model parameters by minimizing the error between the plant data and model predictions. They can be considered to be good approximate methods to address the problem of model mismatch. One way to address this issue is to estimate the model parameters by minimizing the error between the plant data and model predictions by using a nonlinear optimization technique.

### SUMMARY

A method is disclosed to predict the future performance of batch/fed batch fermentation processes using a phenomenological model. Since fermentation processes can be highly nonlinear and vary temporally in their behavior, the model parameters can be re-estimated on-line, to minimize the plant model mismatch. This approach can ensure that the model predictions are closer to the real plant behavior and can be used to improve the operational performance of the batch fermentation unit.

A method is disclosed for on-line prediction of future performance of a plant fermentation unit, comprising: on-line measurement of a plant parameter input variable, including at least one of agitator speed, airflow rate, level measurement, sugar feed rate, broth temperature, % of carbon dioxide and oxygen in a vent gas, and dissolved oxygen in a fermentation broth; entering off-line laboratory analysis results manually in a computer memory connected to a plant control system; fermenter model parameter re-estimation so as to reduce a mismatch between plant data and a model calculation; developing a non-linear fermentation process model which contains the model parameter including at least one of a maximum biomass specific growth rate, Kinetics constant, mass transfer coefficient, product yield constant and cell decay constant which cannot be measured either through on-line measurements or off-line laboratory analysis; and on-line prediction of a future concentration of at least one of biomass, sugar, product, dissolved oxygen in the fermentation broth, and oxygen and carbon dioxide in the vent gas based on current plant data so as to enable controlling the plant parameter using the predicted future concentration.

A method is disclosed for on-line prediction of future performance of a plant fermentation unit, comprising: measuring a control parameter which serves as an input variable of the plant fermentation unit on-line; entering off-line laboratory analysis results manually in a computer memory connected to a plant control system; estimating a value of a model parameter of a fermentation process model that would reduce a mismatch between plant data and a fermenter model calculation; developing a non-linear fermentation process model which contains the model parameter including at least one of a maximum biomass specific growth rate, Kinetics constant, mass transfer coefficient, product yield constant and cell decay constant which cannot be measured either through on-line measurements or off-line laboratory analysis; and predicting a concentration of at least one fermentation performance parameter based on current plant data to control the control parameter using the predicted concentration.

### BRIEF DESCRIPTION OF THE DRAWINGS

FIG. 1 is a schematic representation of an exemplary plant fermentation unit.

FIG. 2 is schematic of on-line prediction of performance parameters of fermenter unit.

### DETAILED DESCRIPTION

In an exemplary approach disclosed herein, the average percentages of prediction error for concentration of biomass and product in the fermenter broth are about 15% and 10% respectively.

Parameters that can be re-estimated on-line are:

Maximum specific growth rate: μₘₐₓ

Contois constant: Kₛₚ

Contois saturation constant: K_{S}

Nominal mass transfer coefficient: k_{L}a₀

Product yield constant: Y_{P/D}

Cell decay constant: K_{dx}

In batch fermentation operations, the process conditions and dynamic behavior change with time and model parameters have to be adjusted to represent the process better. The present disclosure provides a novel method of updating the model parameters and uses the updated model for predicting the future concentration of product, in a batch/fed batch fermentation unit. This provides useful information on future progress of the batch and based on the predictions, one can choose to adjust the control parameters (e.g., operating parameters and/or conditions) such as sugar feed flow rate, air flow or agitator RPM of the fermentation unit, to improve the product yield. The updated model can be used to optimize the operating conditions of the fermenter to maximize the yield.

Exemplary steps in implementation of the proposed online monitoring and control system are as follows:
The process is started by charging media into a fermentation vessel, starting the agitator and initiating the airflow through the broth.
All the plant operating parameters like air flow rate, agitator RPM, broth level, etc. are measured and stored in the control system and are available for the calculations.
Periodically, the broth samples are collected and analyzed in the lab for biomass yield in percentage by volume, concentration of sugar & product and the viscosity. The analysis results are stored in a memory of the plant computer control system.
With the initial conditions (broth volume, product concentration, sugar concentration, dissolved oxygen), and the average profiles of airflow rate, agitator RPM and sugar feed rate, the future concentrations of product, biomass, sugar and dissolved oxygen in the fermenter broth, and composition of vent gas can be calculated and displayed.
The online estimation of fermeter model parameters can be initiated after completion of a predetermined schedule of fermentation startup. The actual process data collected during this startup phase can be used to estimate the parameters, using a computer connected to the control system. The parameters can be estimated by minimizing the error between measured and predicted values for concentration of biomass, product, sugar, dissolved oxygen in the broth and composition (O₂ and CO₂) of vent gas. A non-linear optimization technique can be used for minimizing the error between the predicted and measured values.
The new estimated parameters are stored in the computer and can be used in calculating the future performance parameters.
This re-estimation of the model parameters on-line while the batch is in progress is carried out a few times before completion of the batch, and it helps in reducing the plant-model mismatch leading to improved predictions of performance parameters.

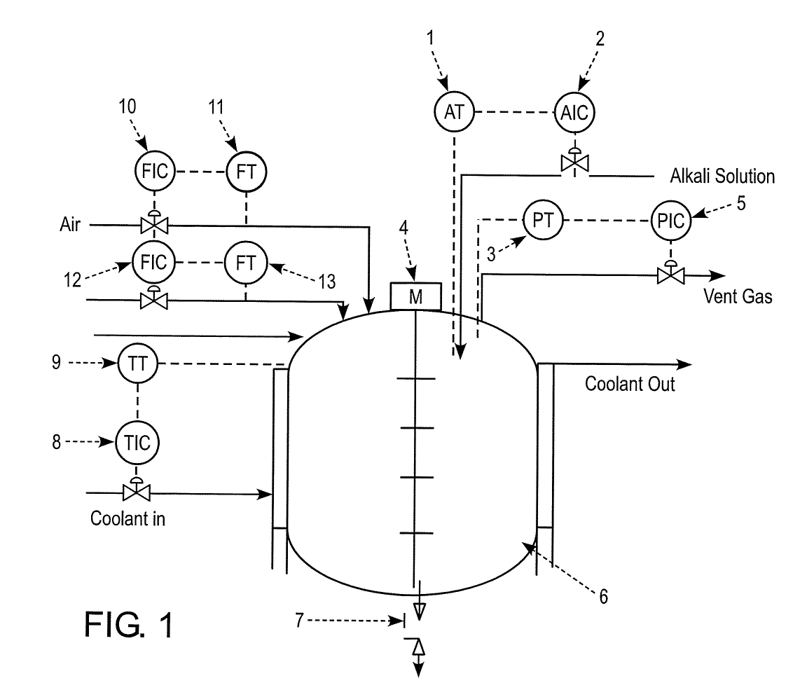

FIG. 1 illustrates a standard fermentation unit having the following automatic control schemes that can be implemented in the fermenter unit control system:

pH control by manipulation of alkali flow rate

Fermenter temperature control by manipulation of coolant flow rate

Flow control for sugar addition

Pressure control by manipulation of vent gas valve

Flow control for inlet air

Adjustment of the agitator RPM through variable speed drive

Exemplary details of the various parts of the fermenter unit shown in FIG. 1 are as follows:

1—Fermenter broth pH transmitter.
2—Fermenter broth pH indicator controller.
3—Fermenter back pressure transmitter.

### 4—Agitator Motor.

5—Fermenter back pressure indicator controller.
6—Fermenter vessel.
7—Fermenter discharge valve.
8—Fermenter temperature indicator controller.
9—Fermenter temperature transmitter.
10—Air flow indicator controller.
11—Air flow transmitter.
12—Sugar flow transmitter.
13—Sugar flow indicator controller.

Various steps involved in an exemplary fermentation process are given below:
Biomass and the media from the lab pre seed vessel are charged in to the main fermenter, which is provided with on-line sensors for measuring, for example, the pH, temperature, dissolved oxygen, volume of the broth, pressure of the vapor space and vent gas analysis for oxygen and carbon dioxide.
pH controller automatically adjusts the flow rate of alkali solution to maintain the fermenter pH at desired value.
After some time, sterile water is added to the fermenter to avoid dissolved oxygen (DO) starvation.
After the addition of sterile water, nutrient is added to provide the nutrients for cell growth.
Addition of sugar solution is started when the concentration of sugar in the broth is lower than a desired value and addition of sugar solution is continued till the end of the batch.
During the course of the operation, one or two intermediate withdrawals of broth may be carried out for recovering the product.
The airflow can be maintained at predefined flow set points.
The agitator RPM is maintained at two different levels: low speed initially and high speed for the remaining period of the batch.

At specified intervals (e.g., every few hours), broth sample is taken and analyzed in the laboratory for biomass yield in percentage by volume, concentration of sugar & alkali and the viscosity and product concentration.

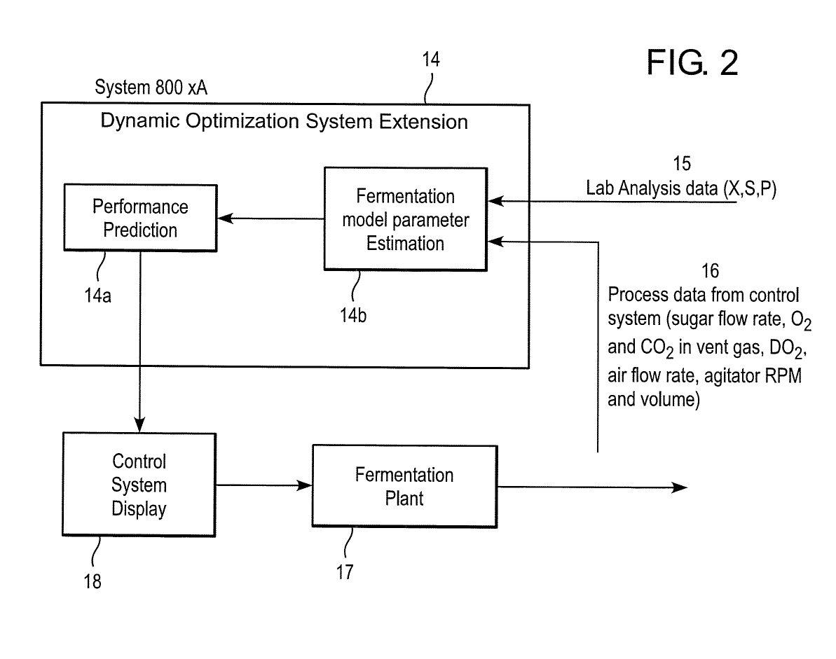

FIG. 2 is schematic of on-line prediction of performance parameters of fermenter unit. The fermenter model is implemented as a software application in Dynamic Optimization System Extension (DOSE) of System 800xA, which is a standard process automation system developed by ABB based on the concept of object oriented approach to design and operation of process automation systems. DOSE is a software framework available in System 800xA and it provides a collection of tools for model-based application. The fermenter mathematical model described above is implemented in DOSE as per the procedure described in the reference manual [Ref. 8]. DOSE provides equation solvers and non-linear optimization routines for simulation and model parameters estimation. Standard features of DOSE and System800xA are used for configuration, execution, display and storage of results obtained during simulation and parameter estimation of the fermenter model.

DOSE, shown in FIG. 2, parts 14, 14(a) and 14(b), can be interfaced with control systems and any other software systems supporting the Object linking and embedding for Process Control standard [hereby referred to as the OPC (Object linking and embedding for Process Control) standard] for data communications. This will help in implementing the fermenter model on-line with data read/write facility with external systems. DOSE provides a collection of tools for model-based applications like simulation, parameter estimation and optimization, shown in FIG. 2, part 14(b). A spreadsheet plug-in provides the interface to configure the data required for carrying out the simulation, estimation or optimization and storing the calculation's results.

The schematic system for on-line prediction of performance parameters like concentration of biomass, sugar and product concentration of fermenter broth is also discussed hereinafter.

### Implementation of On-Line Fermenter Performance Monitoring System in Control System:

In an exemplary embodiment, an unstructured [cell is represented by single quantity like cell density (g dry wt/L)] and unsegregated [view the entire cell population to consist of identical cells (with some average characteristics)] model approach is used for modeling the fermentation process, as this modeling approach is more amenable for on-line applications like estimation, simulation and optimization.

The following exemplary assumptions are made while developing the model:
Density of the fermentation broth is assumed to be same as that of water (1 gm/ml).
The cell growth is influenced by sugar and oxygen concentrations. The dependency on sugar and oxygen is modeled with Contois kinetics, which is an extension of Monod's kinetics [Ref. 9].
The product formation rates are influenced by sugar and oxygen concentration, with sugar exerting inhibitory type control over the production rates.
The sugar consumption is accounted for cell growth, product formation and maintenance
The oxygen mass transfer rates are influenced by agitation rate, air supply rate and viscosity.
Cell growth follows a sequence of lag period, growth period and maintenance or decay period and this is considered in the model.
Perfect mixing in the fermenter.
Temperature and pH in the fermenter are maintained at constant values and the model does not include the effect of these variables on the fermenter performance.

As described above, it has been found that improved prediction of broth concentration can be achieved by on-line updating of the model's parameters to account for the nonlinear and time varying behavior of batch fermentation process. The predictor is depicted in FIG. 2, part 14(a). The parameters can be obtained by minimizing the error between measured and predicted values of variables like concentration of product, sugar concentration, biomass, dissolved oxygen and O₂ and CO₂ concentration in the vent gas. A constrained nonlinear optimization technique can be used to minimize the error. Measured values of the concentration of biomass, product and sugar in the broth are available from lab analysis, shown in FIG. 2, part 15, at specified intervals (e.g., every few hours) and measurements of composition of vent gas and dissolved oxygen concentration are available from the control system at specified intervals (e.g., every few minutes), shown in FIG. 2, part 16.

The fermenter model, shown in FIG. 2, part 14(b), along with the appropriate equation solvers and optimization routines are implemented as a software application module using Dynamic Optimization System Extension framework available in System 800 ax. This is helpful in interfacing the fermenter model software with any other software system supporting OPC standard for data transfer. The predictor's output is displayed on a control system display, shown in FIG. 2, part 18, before being fed to the fermentation plant, shown in FIG. 2, part 17.

A brief description of the mathematical model of the Fermentation Unit is outlined below.

Fermentation processes can be carried out as a batch or fed-batch operation in a stirred tank type of bioreactors with precise control of process conditions such as temperature, pH and dissolved oxygen. Batch/Fed Batch fermentation units can be subjected to unmeasured disturbances leading to large variation in the product yields. Mathematical models can be used for better understanding the fermentation process and also to improve the operation to reduce the product variability and optimal utilization of the available resources.

The development of such a model for batch/fed-batch fermentation processes is disclosed herein to enable on-line prediction of desired performance parameters (e.g., process variables) like concentration of biomass and product. Exemplary fermentation processes are characterized by highly nonlinear, time variant responses of the microorganisms and some of the model parameters are re-estimated on-line to minimize the modeling errors, such that the model predictions are close to the real plant behavior. The model considers both kinetics and transport phenomena occurring in the fermentation process. The model assumes perfect mixing in the fermenter with the cell growth and product formation rate influenced by sugar and oxygen concentrations in the broth. The sugar consumption is accounted for cell growth, product formation and maintenance. The oxygen mass transfer rates are influenced by agitation rate, air supply rate and viscosity.

The model calculations are implemented in a computer that is interfaced with the microprocessor based system used for operation and control of the fermentation unit. Plant operation data can be used by the model to predict the future product concentration of the fermenter broth so that the operators can make suitable changes in the process conditions to maintain desired yield from the batch fermentation unit. Details of the fermenter model are given in the following section.

### Total Mass:

The batch/fed-batch process operation causes a volume change in the fermenter. This is calculated by:

$$\frac{d}{d t} ( V ) = {F}_{i n} + {F}_{str} - {F}_{out} - {F}_{loss}$$

Where V is the volume of the fermenter broth, Fᵢₙ is the flow rate of sugar entering the fermenter, Fₒᵤₜ account for the spillages and Fₗₒₛₛ accounts for evaporation losses during fermentation. The sterile water and nutrient addition term is included as Fₛₜᵣ.

Cell mass in fermenter broth is determined by the following equation:

$$\frac{d}{d t} ( xV ) = {F}_{i n} {x}_{i n} - {F}_{out} x + {μ}_{D} xV - {K}_{dx} xV$$

where x is concentration of biomass in the broth at any time, xᵢₙ is the concentration of biomass in sugar solution and specific growth rate μ_{D} is given by

$${μ}_{D} = {μ}_{max} \frac{S}{{K}_{S} X + S} \frac{{C}_{L}}{{K}_{O} X + {C}_{L}}$$

S and C_{L} are the concentration of sugar and dissolved oxygen in the broth.

### Product in Fermenter Broth:

The product formation is described by non-growth associated product formation kinetics. The hydrolysis of product is also included in the rate expression

$$\frac{d}{d t} ( pV ) = {F}_{i n} {p}_{i n} - {F}_{out} p + {π}_{R} xV - {k}_{d} pV$$

where, p is the concentration of product in the broth at any time, pᵢₙ is concentration of product in sugar solution, k is a constant, π_{R} is the specific product formation rate defined as:

$${π}_{R} = {π}_{max} \frac{S}{{K}_{SP} + S + {K}_{i} {S}^{2}} \frac{{C}_{L}}{{K}_{OP} X + {C}_{L}}$$

### Sugar in Fermenter Broth:

The consumption of sugar is assumed to be caused by biomass growth and product formation with constant yields and maintenance requirements of the microorganism.

$$\frac{d}{d t} ( SV ) = {F}_{i n} {S}_{F} - {σ}_{D} XV - {F}_{out} S$$

where S_{F} is the concentration of sugar in a sugar solution and σ_{D} is the specific sugar consumption rate defined as:

$${σ}_{D} = \frac{{μ}_{D}}{{Y}_{X / D}} + \frac{{π}_{R}}{{Y}_{P / D}} + {m}_{D}$$

### Dissolved Oxygen in Fermenter Broth:

The consumption of oxygen is assumed to be caused by biomass growth and product formation with constant yields and maintenance requirements of the microorganism. The oxygen from the gas phase is continuously being transferred to the fermentation broth.

$$\frac{d}{d t} ( {C}_{L} V ) = {F}_{i n} {C}_{L , i n} + {k}_{L} a ( {C}_{L}^{*} - {C}_{L} ) V - 1000 {σ}_{O} XV - {F}_{out} {C}_{L}$$

where C_{L,in} and C_{L} are concentration of dissolved oxygen in the sugar solution entering and broth respectively. σ_{O} is the specific oxygen consumption rate, defined as:

$${σ}_{O} = \frac{{μ}_{D}}{{Y}_{X / O}} + \frac{{π}_{R}}{{Y}_{P / O}} + {m}_{O}$$

The overall mass transfer coefficient, k_{L}a is assumed to be function of agitation speed (rpm), airflow rate (Fₐᵢᵣ), viscosity (μ) and fermentation broth volume and is defined as:

$${k}_{L} a = {( {k}_{L} a )}_{0} {( \frac{rpm}{{rpm}_{0}} )}^{a} {( \frac{{F}_{air}}{{F}_{air , 0}} )}^{b} {( \frac{{μ}_{0}}{μ} )}^{c} {( \frac{{V}_{0}}{V} )}^{d}$$

where the subscript 0, refers to nominal conditions. The saturation of dissolved oxygen concentration, C*_{L}, is related to the partial pressure of oxygen, pO₂, using Henry's law:

$${C}_{L}^{*} = \frac{ {p O}_{2}}{h}$$

$$D {O}_{2} = ( {C}_{L} / {C}_{L}^{*} ) * 100$$

where DO₂, is the measurement of dissolved oxygen available from the plant measurements.

### Gas Phase Oxygen:

The gas phase is assumed to be well mixed, and the airflow rate is assumed to be constant.

$$\frac{d}{d t} ( \frac{{V}_{g} {Py}_{O 2}}{RT} ) = \frac{{F}_{air} {P}_{0}}{{RT}_{0}} ( {y}_{O 2 , i n} - {y}_{O 2} ) - \frac{{k}_{L} a}{1000 \times 32} ( {C}_{L}^{*} - {C}_{L} ) V$$

Where y_{O2,in} and y_{O2} are mole fraction of oxygen in the air and fermenter vent gas, P and T are the pressure and temperature of vapor space in the fermenter, P₀ and T₀ are pressure and temperature at normal conditions and R is the gas constant and V_{g} is the volume of vapor space in the fermenter.

### Gas Phase Carbon Dioxide:

The introduction of variables that are easy to measure while being important in their information content has been very helpful in predicting other important process variables. One such variable is CO₂ from which cell mass may be predicted with high accuracy. In this work, CO₂ evolution is assumed to be due to growth, product biosynthesis and maintenance requirement. The carbon dioxide evolution is given by:

$$\frac{d}{d t} ( \frac{{V}_{g} {Py}_{CO 2}}{RT} ) = \frac{{F}_{air} {P}_{0}}{{RT}_{0}} ( {y}_{CO 2 , i n} - {y}_{CO 2} ) + \frac{{σ}_{CO 2}}{44} XV$$

Where y_{CO2,in} and y_{CO} are mole fraction of carbon dioxide in the air and fermenter vent gas and σ_{CO2}, is the specific carbon dioxide evolution rate defined as:

σ_{CO2}=Y_{CO2/X}μ_{D}+Y_{CO2/P}π_{R}+m_{CO2}

A list of various kinetic parameters used in the model are listed below:

### Kinetic Parameters:

### Growth

Maximum specific growth rate: μₘₐₓ (h⁻¹)
Contois saturation constant: K_{S}
Oxygen limitation constant for growth K_{O} (mg/L)
Cell decay rate constant: K_{dx} (h⁻¹)

### Product Formation

Specific rate of production: Πₘₐₓ (g/L/h)
Contois constant: Kₛₚ (L⁻²/g⁻²)
Inhibition constant for product formation: Kᵢ (g/l)
Oxygen limitation constant for product: K_{OP} (mg/L)
Product hydrolysis rate constant: K_{d} (h⁻¹)

### Sugar Consumption

Cellular yield constant: Y_{X/D} (g cellmass/g sugar)
Product yield constant: Y_{P/D} (g product/g sugar)
Maintenance coefficient on sugar: m_{D} (h⁻¹)

### Oxygen Consumption

Cellular yield constant: Y_{X/O} (g cellmass/g oxygen)
Product yield constant: Y_{P/O} (g product/g oxygen)
Maintenance coefficient on oxygen: mₒ (h⁻¹)

### Oxygen Transfer

Nominal mass transfer coefficient: k_{L}a₀ (h⁻¹)
Nominal rpm: rpm₀
Nominal air flow rate: F_{air,0} (m³/h)
Nominal viscosity: μ₀ (cP)
Nominal volume: V₀ (L)
Henry's constant: h

### Constants: a, b, c, d

### Gas Phase Oxygen

Normal pressure: P₀ (atm)
Gas phase volume: V_{g} (L)
Gas constant: R (atm m³ gmol⁻¹K⁻¹)
Normal temperature: T₀ (K)

### Gas Phase Carbon Dioxide

Cellular yield constant: Y_{CO2/X} (g carbon dioxide/g cell mass)
Product yield constant: Y_{CO2/P} (g carbon dioxide/g product)
Maintenance coefficient on oxygen: m_{CO2} (per h)

Initially, model parameters of the fermenter model in DOSE are estimated with plant data in off-line mode and tuned to match with real plant data. The tuned model can be used to predict the performance parameters of the fermenter.

In the on-line mode, the model will receive the real-time process data like air flow rate, agitator RPM, sugar flow rate, dissolved oxygen and vent gas composition (oxygen and carbon dioxide) from the plant control system and also the analysis of fermentation broth (biomass yield in percentage volume, concentration of sugar, alkali and product) from the laboratory at specified intervals (e.g., once every few hours). This combination of real-time process data and off-line laboratory data is used to reconcile the measurements and estimate the model parameters. Periodic re-estimation of model parameters reduces the model mismatch and brings the model behavior closer to real operating conditions of the fermenter. The updated model will be used to predict the performance parameters. This cycle of parameter estimation and performance prediction are repeated periodically for monitoring the performance of the fermenter in real-time.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCES

### The Disclosures of which are All Incorporated Herein by Reference in their Entireties

1. Ignova M et al., “Multivariate statistical methods in bioprocess fault detection and performance forecasting”, Trans. Inst. MC, 19, 271-279, 1997.
2. Karim M N et al., “Data based modeling and analysis of bioprocesses: Some real experiences”, Biotechnol. Prog, 19, 1591-1605, 2003.
3. Lennox B et al., “Application of multivariate statistical process control to batch operations”, Comp. Chem. Eng., 24, 291-296, 2000
4. Lennox et al, “Automated production support for the bioprocess industry”, Biotechnol. Prog., 18,269-275, 2002.
5. Lopes J A et al., “Multiblock PLS analysis of an industrial pharmaceutical process”, Biotechology Bioeng, 80, 419-427, 2002.
6. Dhir at al, “Dynamic Optimization of Hybridoma growth in a fed batch Bioreactor”, Biotechnology and Bioengineering, 67(2), 197-205, 2000
7. Iyer M S et al, “Dynamic Reoptimization of a Fed-Batch Fermentor”, Biotechnology and Bioengineering, 63(1), 10-21, 1999.
8. 8.1KGC 003 952 Dynamic Optimization Reference Manual V. 2.1.1, 2005
9. 9. ML Schuler and F Kargi, “Biochemical Engineering Basic Concepts”, Prentice Hall, 2002.

What is claimed is:

1. A method for on-line prediction of future performance of a plant fermentation unit, comprising:
a. on-line measurement of a plant parameter input variable, including at least one of agitator speed, airflow rate, level measurement, sugar feed rate, broth temperature, % of carbon dioxide and oxygen in a vent gas, and dissolved oxygen in a fermentation broth;
b. entering off-line laboratory analysis results manually in a computer memory connected to a plant control system;
c. fermenter model parameter re-estimation so as to reduce a mismatch between plant data and a model calculation;
d. developing a non-linear fermentation process model which contains the model parameter including at least one of a maximum biomass specific growth rate, Kinetics constant, mass transfer coefficient, product yield constant and cell decay constant which cannot be measured either through on-line measurements or off-line laboratory analysis; and
e. on-line prediction of a future concentration of at least one of biomass, sugar, product, dissolved oxygen in the fermentation broth, and oxygen and carbon dioxide in the vent gas based on current plant data so as to enable controlling the plant parameter using the predicted future concentration.

2. A method for on-line prediction of future performance of a plant fermentation unit according to claim 1, wherein a fermenter model parameters is estimated by:
a. measuring values of the concentration of biomass, product and sugar in the fermentation broth through off-line lab analysis, at specified intervals; and
b. measuring on-line the composition of vent gas and dissolved oxygen concentration of the broth from the plant control system, at specified intervals.

3. A method for on-line prediction of future performance of a plant fermentation unit according to claim 1, wherein on-line estimation of fermenter model parameters is initiated after completion of a predetermined schedule of fermentation startup, with actual process data collected during this startup phase being used to estimate the fermenter model parameters, using the computer connected to the plant control system.

4. A method for on-line prediction of future performance of a plant fermentation unit according to claim 1, wherein the fermenter model parameters are estimated by minimizing an error between measured and predicted values for concentration of biomass, product, sugar, dissolved oxygen in the fermentation broth, and composition of vent gas using a non-linear optimization technique.

5. A method for on-line prediction of future performance of a plant fermentation unit according to claim 1, wherein a calculation and display of a predicted future concentration of at least one of product, biomass, sugar, and dissolved oxygen in the fermenter broth, and composition of vent gas, is carried out using current operating conditions and average profiles of airflow rate, agitator RPM and sugar feed rate.

6. A method for on-line prediction of future performance parameters of a fermentation unit according to claim 1 for a batch or a fed-batch unit.

7. A method according to claim 5, wherein the current operating conditions include broth volume, product concentration, sugar concentration, and dissolved oxygen.

8. A method for on-line prediction of future performance of a plant fermentation unit, comprising:
a. measuring a control parameter which serves as an input variable of the plant fermentation unit on-line;
b. entering off-line laboratory analysis results manually in a computer memory connected to a plant control system;
c. estimating a value of a model parameter of a fermentation process model that would reduce a mismatch between plant data and a fermenter model calculation;
d. developing a non-linear fermentation process model which contains the model parameter including at least one of a maximum biomass specific growth rate, Kinetics constant, mass transfer coefficient, product yield constant and cell decay constant which cannot be measured either through on-line measurements or off-line laboratory analysis; and
e. predicting a concentration of at least one fermentation performance parameter based on current plant data to control the control parameter using the predicted concentration.

9. The method for on-line prediction of future performance of a fermentation unit according to claim 9, wherein the fermentation performance parameter includes at least one of biomass, sugar, product, dissolved oxygen in the fermentation broth, and oxygen and carbon dioxide in vent gas.

10. The method for on-line production of future performance of a plant fermentation unit according to claim 9, wherein the control parameter is at least one of agitator speed, airflow rate, level measurement, sugar feed rate, broth temperature, % of carbon dioxide and oxygen in a vent gas, and dissolved oxygen in a fermentation broth.
